(19) United States
(12) Patent Application Publication
(10) Pub. No.: US 2025/0305865 A1
(43) Pub. Date: Oct. 2, 2025

(54) FILL LEVEL MEASURING DEVICE FOR CARRYING OUT A MEASUREMENT

(71) Applicant: VEGA Grieshaber KG, Wolfach (DE)

(72) Inventors: Christian HOFERER, Offenburg (DE); Manuel KAUFMANN, Berghaupten (DE); René HERRMANN, Oberwolfach (DE)

(73) Assignee: VEGA Grieshaber KG, Wolfach (DE)

(21) Appl. No.: 19/091,023

(22) Filed: Mar. 26, 2025

(30) Foreign Application Priority Data
Mar. 26, 2024 (DE) 10 2024 202 862.2

(51) Int. Cl. G01F 23/284

(52) U.S. Cl. CPC G01F 23/284

(57) ABSTRACT

A radar level measuring device is provided, the device being configured to perform a measurement for determining a level of a filling material by a frequency modulated continuous wave measurement method, the radar level measuring device including: a transmitting device configured to transmit a radar signal in a direction of a filling material surface to perform the measurement; a receiving device configured to receive the radar signal reflected from the filling material surface and to evaluate the measurement; a control device configured to control the transmitting device and the receiving device; and a selection device configured to select a parameter set for controlling the transmitting device and the receiving device, the parameter set including at least a measurement duration of the measurement, a minimum measurement frequency and a maximum measurement frequency of the measurement, and a number of consecutive measurements.

### CROSS-REFERENCE TO RELATED APPLICATIONS

This application claims the benefit of priority under 35 U.S.C. § 119 from German Patent Application No. 10 2024 202 862.2 filed on 26 Mar. 2024, the entire content of which is incorporated herein by reference.

### TECHNICAL FIELD

The disclosure relates to a fill level measuring device for carrying out a measurement, in particular a fill level measuring device whose parameters for carrying out the measurement can be selected by means of a selection device. The disclosure also relates to a use, a method and a non-volatile, computer-readable storage medium.

### BACKGROUND

A level measurement can be carried out for a variety of measurement situations. A measurement situation can, for example, include a specific filling material/product, a specific dynamic of the product, i.e., its filling and/or emptying behaviour, a maximum distance between a minimum and a maximum fill level, optimization criteria such as a measurement that is as accurate as possible or as energy-saving as possible, and/or other circumstances of the measurement. In at least some cases, it may be necessary to adapt the fill level measuring device for the specific measurement situation. It would therefore be desirable if the fill level measuring device could perform at least some of the adaptations to a specific measurement situation automatically.

### SUMMARY

It is an object of the disclosure to provide a device and/or a method which can automatically perform at least part of the adjustments of a fill level measuring device to a specific measuring situation. This object is solved by the subject matter of the independent patent claims. Further embodiments of the disclosure result from the dependent claims and the following description.

One aspect relates to a radar level measuring device configured to perform a measurement for determining a level of a filling material, wherein the determination of the level is performed by means of an FMCW (FMCW: Frequency Modulated Continuous Wave Radar, or continuous wave radar) measurement method. The radar level measuring device comprises: a transmitting device configured to transmit a radar signal in the direction of a filling material surface to perform the measurement; a receiving device configured to receive the radar signal reflected from the filling material surface and to evaluate the measurement; a control device configured to control the transmitting device and the receiving device; and a selection device configured to select a set of parameters for controlling the transmitting device and the receiving device, wherein the parameter set comprises at least a measurement duration of the measurement, a minimum measurement frequency and a maximum measurement frequency of the measurement, and a number of consecutive measurements.

### BRIEF DESCRIPTION OF THE FIGURES

The figures show:

FIG. 1 shows a schematic of a radar level measuring device according to an embodiment;

FIGS. 2a and 2b show a schematic of one or more measurements according to an embodiment;

FIGS. 3a-3f show schematic effects of different parameters according to an embodiment; and

FIG. 4 is a flowchart showing a process according to an embodiment.

### DETAILED DESCRIPTION OF EMBODIMENTS

The radar level measuring device can, for example, be configured to carry out a measurement to determine a fill level, to determine a topology, and/or to determine a limit level of a filling material. The filling material can be, for example, a liquid, including an emulsion or suspension, or a bulk material, in particular a granulated or powdery bulk material. The medium or filling material can be, for example, a liquid, e.g., water, juice, milk, alcohols, oils, paint, ketchup, or a bulk material such as flour, sand, coffee powder, plastic granulate, and/or another type of medium or product. The medium can be in a container. The container can be, for example, a vessel or a measuring tank, process tank, storage tank, or silo of any shape. For example, the container can be an intermediate bulk container (IBC). The container can also be a channel, such as a stream or riverbed. The fill level, the topology, or the limit level is determined using a so-called FMCW (FMCW: Frequency Modulated Continuous Wave Radar, or continuous wave radar) measurement method. The radar waves used for this can cover a frequency range of 1 to 300 GHz, for example from 50 to 100 GHz.

The radar level measuring device comprises a transmitting device configured to transmit a radar signal in the direction of a filling material surface in order to perform the measurement. The transmitting device comprises a radar sensor unit with a radar antenna of any shape, e.g., a horn antenna, a planar antenna, and/or any other shape of radar antenna. The type and/or shape of the radar antenna may depend on the frequency range used for the measurement.

The radar level measuring device also comprises a receiving device configured to receive the radar signal reflected by the filling material surface. Furthermore, the receiving device is configured to evaluate the measurement. The evaluation of the measurement can include, for example, determining the fill level, etc. Alternatively or additionally, the evaluation can include the determination of parameters of the measurement, for example a signal-to-noise ratio of the reflected radar signal.

The radar level measuring device further comprises a control device configured to control the transmitting device and the receiving device. Controlling the transmitting device and the receiving device can include transmitting a parameter set to the transmitting device and/or the receiving device, which influences the measurement and/or includes optimizations for a specific measurement situation. The parameters of the parameter set can be valid for one measurement or for a plurality of measurements. Depending on the type of radar level measuring device, a different number of parameters can be variable. For example, one type of radar level may have an A/D (analog-to-digital) converter with a variable bit width, but another type of radar level measuring device may have an A/D converter with a fixed, i.e., non-variable, bit width. The parameter set can therefore have a mask by which a subset of the parameter set is determined or defined as non-variable. This determination of the subset of the parameter set as invariable can influence the selection of the (optimum) parameter set.

The radar level measuring device further comprises a selection device configured to select a parameter set. The parameter set can be used to control and/or one of the transmitting device and/or the receiving device. The control can include an adaptation to a measurement situation and/or to a specific type of radar level measuring device. The parameter set comprises at least a measurement duration of the measurement, a minimum measurement frequency and a maximum measurement frequency of the measurement, and a number of consecutive measurements. The distance between the minimum measurement frequency and the maximum measurement frequency of the measurement is sometimes referred to as the “chirp bandwidth”. If a “chirp” or frequency ramp starts at 80 GHz, for example, and runs up to 84 GHz, the bandwidth is accordingly 4 GHz. With the so-called FMCW measurement method, the measurement frequency is changed—e.g., continuously or in steps—from the minimum measurement frequency to the maximum measurement frequency. At least some FMCW measurement methods can change the measurement frequency from the maximum to the minimum measurement frequency; the following explanations apply analogously to these measurement methods.

A radar fill level measuring device configured in this way is thus enabled to automatically perform at least some of the adjustments of the fill level measuring device to a specific measurement situation, which are desirable and/or necessary for an optimized measurement. This can point the way to the use of a type of generic radar level gauge in which the optimized parameters are determined automatically during operation. In addition, the methodology described can provide a basis for further optimizing the automatically optimized measurement, in particular by taking into account other influencing variables relevant to the measurement. A selection and/or examples of relevant influencing variables are described below.

In some embodiments, the selection of the parameter set is (at least) dependent on a signal-to-noise ratio of the reflected radar signal, wherein the signal-to-noise ratio has been determined by the receiving device from an evaluation of at least one preceding measurement. The signal-to-noise ratio is defined as the ratio between an amplitude of the reflected radar signal and the measured noise level. In a (conventional) representation of the amplitude of the reflected radar signal and the noise level, the signal-to-noise corresponds to a difference between the amplitude of the reflected radar signal and the measured noise level. So that the parameters of the parameter set are available before the measurement, the signal-to-noise ratio can be determined by the receiving device from an evaluation of at least one previous measurement. In at least some cases, e.g., for a measurement after a reset of the radar level measuring device, the signal-to-noise ratio used for the selection of the parameter set can be a predefined value.

In some embodiments, the parameter set may further comprise the following parameters, which may also be referred to as a partial parameter set for the transmitting device:
An amplitude (or transmission power) of the radar signal to be transmitted. In order to save energy, it can be advantageous not to always perform a measurement with the same amplitude of the radar signal to be transmitted. Although a large amplitude of the transmitted signal can be useful for a meaningful measurement result, this can lead to unnecessarily high energy consumption, especially for radar level gauges that are not connected to a regular power supply. For example, at a high fill level—i.e., the filling material surface is close to the transmitting and/or receiving antenna—a much lower transmitting power may be sufficient for a meaningful measurement result. Adjusting the amplitude of the transmission signal can be particularly advantageous for autonomous radar level measuring devices, which should consume as little energy as possible—e.g., for the longest possible maintenance interval.
A ramp slope of the measurement. The ramp slope is the increase in the measurement frequency per unit of time. For a fast measurement—which may be useful and/or necessary if the radar level changes quickly, for example—a high ramp slope may be optimal. For a slow change in the radar level, a low ramp may be sufficient. This can lead to a reduction in energy consumption, for example.
A pause length between every two measurements. A short pause length, e.g., even a pause length of zero, can be useful and/or necessary, for example, if the radar level changes quickly and/or to optimize the signal-to-noise ratio. A long pause length can be useful if the radar level changes slowly. Automated adjustment of the pause length can be useful for certain measurement situations. For example, a long pause length may be optimal for a channel with normal water levels, but a short pause length may be optimal when floods occur.

In some embodiments, the parameter set may further comprise the following parameters, which may also be referred to as a partial parameter set for the receiving device:
A number of sampling points or the sampling frequency during the measurement duration of the measurement. A high number of sampling points can, for example, lead to a better signal-to-noise ratio. For example, the noise level decreases by 3 dB if the number of sampling points is doubled.
A bit width of an A/D converter. For a radar level measuring device with a variable bit width of an A/D converter, it may make sense to increase the bit width at low levels, i.e., a long distance to the antenna. On the other hand, a high bit width can mean a higher processor load—and thus higher energy consumption—not only during measurement, but also during further processing of the measurement values.
An evaluation strategy of consecutive measurements. As an evaluation strategy, a distinction can be made between an evaluation of each individual measurement and an evaluation of cumulative measurements (“ensemble averaging” or “array averaging”). For example, the noise level is reduced by 3 dB if two cumulative measurements are used.

In some embodiments, the selection of the parameter set is further dependent on:
An amplitude of the reflected radar signal. In particular, the amplitude of the reflected radar signal of the radar signal reflected on the filling material surface may be relevant. For other measurements, a separating surface between two media and/or an amplitude of the radar signal reflected from the bottom of a container may also be relevant. The amplitude of the reflected radar signal can depend on the type of medium of the filling material. If the amplitude is low, it may be optimal to increase the transmission amplitude and/or the signal-to-noise ratio, for example.
The bit width of the A/D converter of the receiving device. For example, a trade-off or compromise between sampling frequency (number of sampling points or sampling points) and bit width may be optimal.
A currently available energy in an energy storage unit. For example, the pause length can be extended if there is little energy available.
A speed of a change in the level of the filling material. If, for example, the measurement duration is too long, ensemble averaging can worsen the signal-to-noise ratio if the filling material surface has moved between two individual measurements. For example, in the worst case, a moving filling material surface can lead to a reflected signal that is 180° out of phase between two individual measurements; this leads to a reduced echo amplitude and thus further reduces the signal-to-noise ratio. For this reason, it may be optimal to take the movement history into account when selecting the measurement method. If a filling material surface moves at a speed that has a negative effect on the ensemble averaging, the measurement method can be selected so that only one individual measurement is carried out at a time. Increased sensitivity is then dispensed with

Furthermore, the measurement method can be defined depending on the parameterization. This can particularly affect devices that are parameterized by the customer/service during commissioning. For example, a customer can select the medium to be measured. In at least some cases, this selection can be used to derive what the reflection properties will be, i.e., a set of parameters can already be inferred on the basis of this input. For example, a poorly reflective medium requires a measurement method to increase the signal-to-noise ratio. For this purpose, for example, a shear averaging could be preset.

The expected position of the reflection can also be taken into account, for example. For example, reflections that are further away may have a lower amplitude than reflections that are closer, i.e., the amplitude of the level may be distance-dependent. With this knowledge, the measurement method can be selected. A simple set of rules provides that a set (i.e., a subset) of parameters of distant reflectors leads to a measurement method with increased signal-to-noise ratio, which can be realized, e.g., by coulter averaging.

The set of parameters can also be dependent on hardware resources. An example of this is a currently available memory, i.e., a size of memory that can be used for the calculations mentioned. If, for example, the memory is allocated dynamically (e.g., as a heap, with “malloc”, “new”, etc.), situations may arise in which only a small amount of memory is available. As a result, fewer sampling points of a measurement can be processed. This can reduce the signal-to-noise ratio.

The set of parameters can also be selected from a result of an optimization function. If, for example, several sampled signals can be stored in the memory, the signal processing can optimize the signal-to-noise ratio. For example, two or more such stored beat curves or echo curves can be evaluated cumulatively and compared with signals in the memory that were calculated on the basis of a different combinatorics. The combination with the highest signal-to-noise ratio can then be used for an evaluation. If, for example, there are 4 beat curves in the memory, a first average of all 4 beat curves can lead to an SNR (signal noise ratio) of, e.g., 80 dB, whereas a second average (of curves 1 and 2 only) can lead to 85 dB and a third average (of curves 3 and 4 only) can lead to 80 dB. The second type of averaging is therefore preferable.

Alternatively, the beat curves can be evaluated for phase position before averaging. One criterion here can be that the averaging only takes place, for example, if the beat curves interfere constructively. This evaluation can take place both in the time domain of the beat curve and in the frequency domain of the echo curve.

The set of parameters can also be selected depending on environmental data. For example, the noise (thermal noise) can increase at a high ambient temperature and the amplitude of the received and processed signal can decrease. This effect can also be counteracted with ensemble averaging, for example. Other environmental influences, such as high humidity or an outgassing liquid, can also attenuate the radar signal. Such environmental influences can also be counteracted with an adapted set of parameters.

In some embodiments, the selection of the parameter set is performed on the basis of a table, or the selection of the parameter set is performed on the basis of a determination of each individual parameter of the parameter set. If a table is selected as the basis, then this can, for example, be based on a series of empirical values for which measurement situation which parameters have proven to be optimal. If the selection of the parameter set is carried out on the basis of a determination of each individual parameter of the parameter set, this may require increased computing power. In addition, it may be useful to verify how well the calculated parameters actually fit a measurement situation. Both embodiments can be combined, for example, in such a way that parameters rated as good are made available as a special parameter set.

In some embodiments, the parameter set is selected using a neural network (ANN, Artificial Neural Network). The ANN can be arranged in the radar level measuring device and/or in a cloud. Training of the ANN can include a large number of measurement situations and their respective optimum parameters.

In some embodiments, the selection of the parameter set comprises a selection of a predefined parameter set. A predefined parameter set can be used, for example, after a reset of the radar level measuring device. A predefined parameter set can be specified by a service technician, for example. If, for example, a customer or service technician specifies during commissioning of the fill level measuring device that, for example, a bulk material or a strongly moving surface is to be measured, a sensitive measuring method can be selected. Switching to a less sensitive measurement method during operation can take place in a later step after evaluating the signal-to-noise ratio, if necessary using a method as described above and/or below. Measurement cycles can also be saved if it is already known that the expected echo amplitude or the reflected radar signal will be low.

In some embodiments, a subset of the parameter set is determined to be invariant. For example, one type of radar level measuring device may comprise an A/D converter (analog-to-digital converter) having a variable bit width, but another type of radar level measuring device may comprise an A/D converter having a fixed, i.e., non-variable, bit width. The parameter set may therefore have a mask by which a subset of the parameter set is determined or defined as non-variable. This determination of the subset of the parameter set as invariable can influence the selection of the (optimum) parameter set.

One aspect relates to the use of a radar level measuring device as described above and/or below for level measurement, topology determination and/or limit level determination.

One aspect relates to a method for carrying out a measurement by means of a radar level measuring device as described above and/or below for determining a filling level of a filling material, comprising the steps of:
performing a first measurement, wherein performing the first measurement comprises:
transmission of a first radar signal in the direction of a filling material surface,
receiving the first radar signal reflected from the filling material surface, and
evaluating the measurement, wherein evaluating the measurement comprises at least determining a signal-to-noise ratio of the reflected first radar signal; and
performing a second measurement, wherein performing the second measurement comprises:
selecting a parameter set for the second measurement,
transmission of a second radar signal in the direction of the filling material surface according to a partial parameter set for the transmission device,
receiving the second radar signal reflected from the filling material surface according to a partial parameter set for the transmitting device, and
evaluation of the second measurement, whereby the evaluation of the second measurement comprises the determination of the fill level.

One aspect relates to a non-volatile computer readable storage medium having a program stored therein, which, when configured on a processor of a radar level measuring device as described above and/or below, instructs the device to perform the steps as described above and/or below.

It should also be noted that the various embodiments described above and/or below can be combined with one another.

For further clarification, the disclosure is described with reference to embodiments illustrated in the figures. These embodiments are to be understood only as examples and not as limitations.

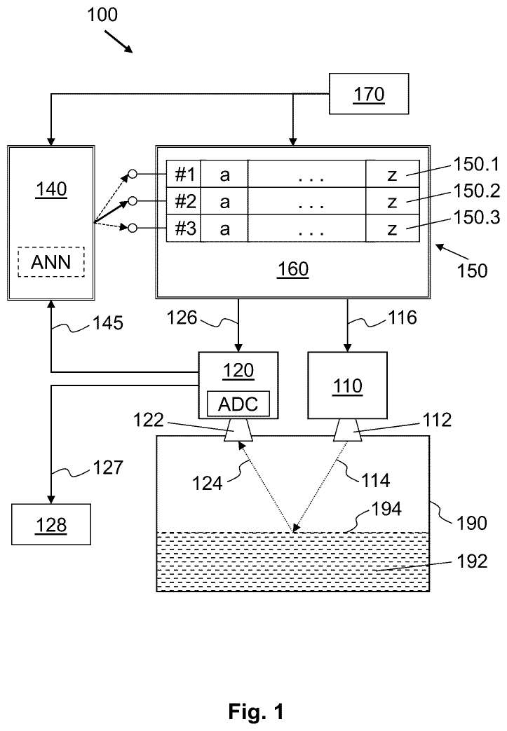

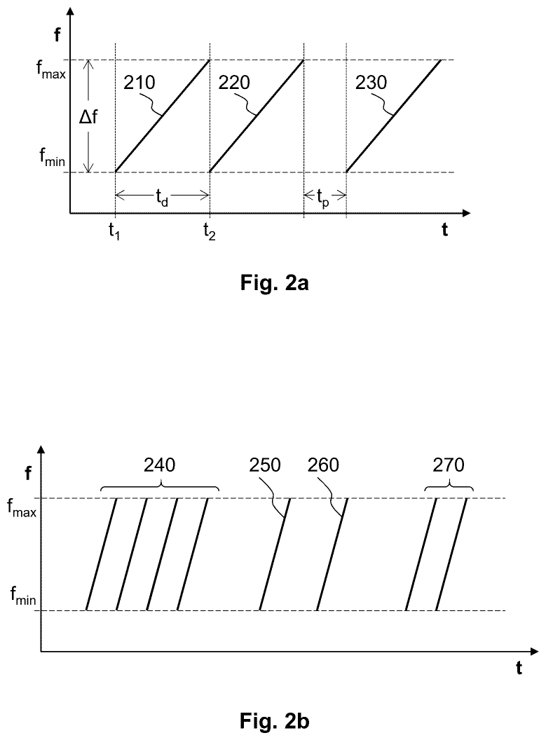

FIG. 1 schematically shows a radar level measuring device 100 according to an embodiment. The radar level measuring device 100 is configured to perform a measurement 210, 220, 230 (see FIG. 2a) to determine a level 194 of a filling material 192. The level 194 is determined by means of an FMCW measurement method. The radar level measuring device 100 comprises a transmitting device 110 configured to transmit a radar signal 114 in the direction of a filling material surface 194 of a container 190. The position of the filling material surface 194 is referred to as the fill level 194 of the filling material 192. The transmission of the radar signal 114 can be interpreted as a (first) part of a measurement 210. A further part of the measurement of the measurement 210 comprises receiving the radar signal 124 reflected from the filling material surface 194 by means of a receiving device 120. The reflected radar signal 124 is digitized by means of an A/D converter ADC and can then be further processed. The receiving device 120 is further configured to evaluate the measurement 210. The evaluation of the measurement 210 can comprise, for example, the determination of the fill level 194, a topology (in particular in the case of an uneven filling material surface 194), and/or a limit level determination. This evaluation can, for example, be transmitted to a control station 128. The transmission can take place, for example, via a two-wire interface or another connection. Alternatively or additionally, the evaluation may comprise determining parameters of the measurement, for example a signal-to-noise ratio of the reflected radar signal 124. The transmitting device 110 and the receiving device 120, with their respective antennas 112 and 122, are shown in FIG. 1 as separate devices; however, the devices 110 and 120 may be integrated into one device. The antennas 112 and 122 may also be realized as a single antenna.

The transmitting device 110 and the receiving device 120 are controlled by a control unit 160. At least some of the parameters of the transmitting device 110 and the receiving device 120 may be variable. At least some of these variable parameters can be changed by the control unit 160 via interfaces 116 and 126. For this purpose, the control 160 may comprise a table 150 which contains, for example, a list (e.g., an array) of parameter sets 150.1, 150.2, 150.3. Each of the parameter sets 150.1, 150.2, 150.3 can comprise an ordered set of optimized or optimal parameters for one measurement situation each. A simple example of a parameter set can be:
td=5 ms
fmin=80 GHz
fmax=84 GHz
n_mess=4

with: td=measurement duration, fmin=minimum measurement frequency, fmax=maximum measurement frequency, n_mess=Number of consecutive measurements.

A selection of a parameter set 150.1, 150.2, 150.3 for controlling the transmitting device 110 and the receiving device 120 is made by a selection device 140. In the exemplary embodiment shown, the parameter set 150.2 is selected. The selection of the parameter set 150.2 from the parameter sets 150.1, 150.2, 150.3 shown can take into account a large number of criteria or be dependent on these criteria. As an example, the selection of the parameter set 150.2 may depend on a signal-to-noise ratio of the reflected radar signal 124. The signal-to-noise ratio may have been determined by the receiving device 120 from an evaluation of at least one previous measurement 210. In at least some cases, for example for a measurement after a reset of the radar level measuring device 100, the signal-to-noise ratio used for selecting the parameter set 150.2 may be a predefined value. The selection device 140 may comprise an artificial neural network (ANN).

The radar level measuring device 100 further comprises an energy storage unit 170, which supplies the individual units of the radar level measuring device 100 with energy. The energy storage unit 170 can be a rechargeable battery, for example. The battery can be charged, for example, via the line 127 or in another way. The currently available energy in the energy storage 170 can be a criterion for selecting the parameter set 150.2.

FIGS. 2a and 2b schematically show one or more measurements 210, 220, 230 according to an embodiment. FIG. 2a shows a first measurement 210 with a measurement duration t_{d}, between the times t₁ and t₂. During the measurement duration t_{d} of the measurement 210, the frequency f is changed between a minimum measurement frequency fₘᵢₙ and a maximum measurement frequency fₘₐₓ. Such a measurement is also referred to as a “sweep” or “chirp”. FIGS. 2a and 2b show a linear frequency change Δf from fₘᵢₙ to fₘₐₓ. However, the frequency change can also be designed differently, for example from fₘₐₓ to fₘᵢₙ and/or in steps.

FIG. 2b shows examples with a different number of consecutive measurements in each case. One measurement 240 comprises a nₘₑₛₛ=4. This can reduce the signal-to-noise ratio by 6 dB compared to a single measurement, i.e., with nₘₑₛₛ=1, as realized in measurements 250 and 260. Measurement 270 comprises an nₘₑₛₛ=2. The different number of consecutive measurements can be optimal, for example, due to a different measured fill level in each case.

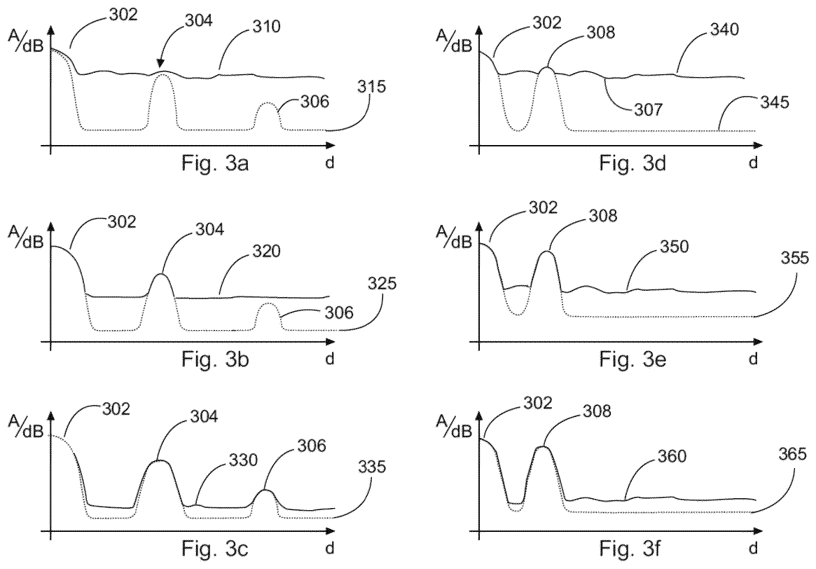

FIGS. 3a-3f schematically show effects of different parameters, e.g., of a different bit width of the A/D converter ADC, according to an embodiment. FIGS. 3a to 3f show echo curves 310, 320, 330, 340, 350, 360, which can be measured with a different bit width of the ADC in each case. The echo curve 310 of FIG. 3a, digitized by means of the ADC, is generated by the ADC with a first accuracy, for example an amplitude resolution of 10 bits, from an analog echo curve corresponding to the dotted echo curves 315 (FIG. 3a), 325 (FIG. 3b), 335 (FIG. 3c). It is clearly recognizable that neither the echo 304 nor the echo 306 of echo curve 315 are mapped in the digital echo curve 310 of FIG. 3a. Operating the measuring device with an amplitude resolution of 10 bits therefore leads to incorrect measurements in this example. If the same analogue echo curve, as shown in FIG. 3b as curve 325, is digitized with a second quantization accuracy m, for example an amplitude resolution of 12 bits, the echo 304 can be resolved well, whereas the actual level echo 306 of echo curve 325 can still not be detected due to its low amplitude. For the measurement situation of the almost full container 20, it may therefore be necessary to control the ADC via the quantization stage determination device 152 in such a way that it detects the echo curve with 14 bits, as shown in FIG. 3c. This allows all relevant echoes 304, 306 to be reliably detected.

In a different measurement situation, for example with a nearly full container 190, the measuring device 100 may behave differently. An echo curve 340 digitized with a first amplitude resolution of 10 bits, as shown in FIG. 3d, can already correctly resolve the filling material echo 308. To increase reliability, it may also be necessary to require a greater signal-to-noise ratio for the filling material echo 308. With a second amplitude resolution of 12 bits, see curve 350 in FIG. 3e, the digitized echo curve 350 can be used to measure the filling material echo 308 very reliably. A further increase in the accuracy of the analog-to-digital conversion to 14 bits, as shown in curve 360 in FIG. 3f, does not generate any additional information. This finer resolution of the amplitude can therefore be dispensed with in this measurement situation. This can result in a reduction in the energy requirement. It may therefore make sense to use a different parameter set, such as 150.3, for a different current fill level.

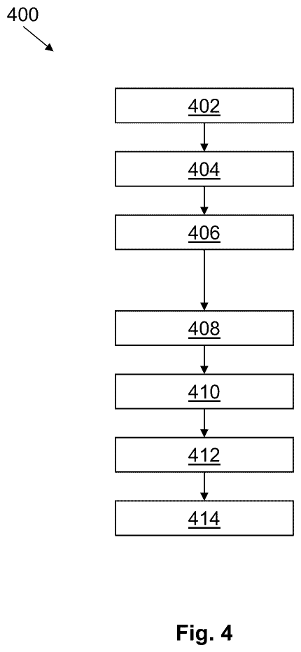

FIG. 4 shows a flowchart 400 illustrating a method of performing a measurement 210 using a radar level measuring device 100 according to an embodiment. In a step 402, a first radar signal 114 is transmitted towards a filling material surface 194. In a step 404, first radar signal 124 reflected from the filling material surface 194 is received. In a step 406, the measurement 210 is evaluated, wherein evaluating the measurement 210 comprises at least determining a signal-to-noise ratio of the reflected first radar signal 124.

In a step 408, a parameter set 150.1 is selected for the second measurement 220, wherein the selection of the parameter set 150.1 is dependent on the signal-to-noise ratio of the reflected first radar signal 124. In a step 410, a second radar signal 114 is transmitted in the direction of the filling material surface 194, according to a partial parameter set for the transmitting device 110. In a step 412, the second radar signal 124 reflected from the filling material surface 194 is received, according to a partial parameter set for the transmitting device 110. In a step 414, the second measurement 220 is evaluated, wherein evaluating the second measurement 220 comprises determining the fill level 194.

### LIST OF REFERENCE NUMERALS

100 Radar level gauge
110 Transmitter
112 Antenna
114 Radar signal
116 Interface
120 Receiving device
122 Antenna
124 Reflected radar signal
126 Interface
127 Management
128 Control station
140 Selection device
150 Table with parameter sets
160 Control unit
170 Energy storage
190 Container
192 Filling material
194 Fill level, filling material surface
150.x Parameter set
170 Energy storage
210-270 Measurements
304-308 Maxima
310-340 Measurements
315-365 Echo curves
400 Flowchart
402-414 Steps

1. A radar level measuring device configured to perform a measurement for determining a level of a filling material by a frequency modulated continuous wave (FMCW) measurement method, the radar level measuring device comprising:
a transmitting device configured to transmit a radar signal in a direction of a filling material surface to perform the measurement;
a receiving device configured to receive the radar signal reflected from the filling material surface and to evaluate the measurement;
a control device configured to control the transmitting device and the receiving device; and
a selection device configured to select a parameter set for controlling the transmitting device and the receiving device,
wherein the parameter set comprises at least a measurement duration (t_{d}) of the measurement, a minimum measurement frequency (fₘᵢₙ) and a maximum measurement frequency (fₘₐₓ) of the measurement, and a number of consecutive measurements.

2. The radar level measuring device according to claim 1,
wherein the selection of the parameter set is dependent on a signal-to-noise ratio of the reflected radar signal, and
wherein the signal-to-noise ratio has been determined by the receiving device from an evaluation of at least one preceding measurement.

3. The radar level measuring device according to claim 1, wherein the parameter set further comprises the following partial parameter set for the transmitting device:
an amplitude of the radar signal to be transmitted,
a ramp slope (Δf/t_{d}) of the measurement, and/or
a pause length (tₚ) between every two measurements.

4. The radar level measuring device according to claim 1,
wherein the parameter set further comprises the following partial parameter set for the receiving device:
a number of sampling points during the measurement period (t_{d}) of the measurement,
a bit width of an A/D converter, and/or
an evaluation strategy of successive measurements, and
wherein the evaluation strategy comprises evaluating each of the successive measurements individually or evaluating the measurements cumulatively.

5. The radar level measuring device according to claim 1, wherein the selection of the parameter set is dependent on:
an amplitude of the reflected radar signal,
the bit width of the A/D converter of the receiving device,
a currently available energy in an energy store, and/or
a speed of a change in the filling level of the filling material.

6. The radar level measuring device according to any claim 1,
wherein the selection of the parameter set is carried out based on a table, or
wherein the selection of the parameter set is carried out based on a determination of each individual parameter of the parameter set.

7. The radar level measuring device according to claim 1,
wherein the selection of the parameter set is carried out by means of a neural network.

8. The radar level measuring device according to claim 1,
wherein the selection of the parameter set comprises a selection of a predefined parameter set.

9. The radar level measuring device according to claim 1,
wherein a subset of the parameter set is determined to be invariable.

10. The radar level measuring device according to claim 1, the radar level measuring device being further configured for level measurement, for topology determination, and/or for limit level determination.

11. A method for performing a measurement by a radar level measuring device according to claim 1 for determining a level of a filling material, comprising the steps of:
performing a first measurement comprising:
transmitting a first radar signal in a direction of a filling material surface,
receiving the first radar signal reflected from the filling material surface, and
evaluating the measurement, the evaluating comprising at least determining a signal-to-noise ratio of the reflected first radar signal; and
performing a second measurement comprising:
selecting a parameter set for the second measurement,
transmitting a second radar signal in the direction of the filling material surface in accordance with a partial parameter set for the transmission device,
receiving the second radar signal reflected from the filling material surface according to a partial parameter set for the transmitting device, and
evaluating the second measurement, the evaluating comprising determining the fill level.

12. A non-volatile computer-readable storage medium having a program stored therein which, when executed on a processor of a radar level measuring device according to claim 1, instructs the radar level measuring device to perform the steps of:
performing a first measurement comprising:
transmitting a first radar signal in a direction of a filling material surface,
receiving the first radar signal reflected from the filling material surface, and
evaluating the measurement, the evaluating comprising at least determining a signal-to-noise ratio of the reflected first radar signal; and
performing a second measurement comprising:
selecting a parameter set for the second measurement,
transmitting a second radar signal in the direction of the filling material surface in accordance with a partial parameter set for the transmission device,
receiving the second radar signal reflected from the filling material surface according to a partial parameter set for the transmitting device, and
evaluating the second measurement, the evaluating comprising determining the fill level.
